(19) United States
(12) Patent Application Publication
(10) Pub. No.: US 2013/0124457 A1
(43) Pub. Date: May 16, 2013

(54) APPARATUS, SYSTEM AND METHOD OF STORING, TRACKING AND DISSEMINATING DOCUMENTS RELATED TO FOOD PRODUCTS

(71) Applicant: James W. Parker, Huntington Beach, CA (US)

(72) Inventor: James W. Parker, Huntington Beach, CA (US)

(73) Assignee: CSM BAKERY PRODUCTS NA, INC., Tucker, GA (US)

(21) Appl. No.: 13/297,150

(22) Filed: Nov. 15, 2011

(51) Int. Cl. G06F 17/30

(52) U.S. Cl. 707/608; 707/E17.008

(57) ABSTRACT

An apparatus used to store, track and disseminate documents related to a food product is a repository that comprises electronic document generator, database, and query module is. The electronic document generator receives a document related to a food product and certificates related to the food product. The electronic document generator generates electronic document based on the document including the product information and also generates electronic copies of the certificates. The database is coupled to the electronic document generator and stores the electronic copies of the electronic document and the certificates. The query module is coupled to the database and receives a query related to the food product. The query includes data generated by document recognition or by QR Code scanning. The query module provides access to the electronic document and electronic copies of the certificates associated with the query. Other embodiments are also disclosed.

### FIELD

Embodiments of the invention relate generally to apparatuses, systems, and methods of storing, tracking and disseminating documents related to food products.

### BACKGROUND

In the food manufacturing, food distribution, and food service industries, various documents for each of food product are required by governmental agencies. Further, each supplier, manufacturer, distributor and wholesaler may also require different food product information or certificates be provided. For instance, the food product information may include supplier identifications, lot or batch numbers, Global Trade Item Number (GTIN) codes, document types, manufacturing data, expiration dates, etc. . . Further, different distributors and wholesalers may require that various food certificates be provided at differing frequencies. These certificates may include, for example, the certificate of analysis, a nutritional statement, and kosher certification.

Currently, at each step of the supply chain, numerous documents containing a vast array of information must be manually created and manually entered into a local database. For example, the manufacturers must manually create documents including the food information and certificates required by the governmental agencies to a distributor. A single truck going to a given distributor may carry a variety of products having different lot numbers. For each lot number, the manufacturer may be required to provide a separate certificate of analysis and kosher certificate. Further, once received, the distributor must manually enter the documents and certificates into their local database and maintains records for a required amount of time.

Accordingly, there current system is inefficient, time consuming and tedious because each of the suppliers, manufacturers, distributors and wholesalers are required to maintain their own local database.

### SUMMARY

Apparatuses, systems, and methods of storing, tracking and disseminating documents related to food products are described herein.

In one embodiment of the invention, a repository, which may be a server or a cloud computing system, stores a plurality of documents and certificates respectively related to a plurality of food products. The plurality of documents is respectively associated with a supplier identification such as a Global Trade Item Number (GTIN) and a Data Universal Number System (DUNS). In this embodiment, a method of using the repository starts by the repository receiving a document related to a food product and one or more certificates related to the food product. The document comprises product information may include the supplier identification and a lot or batch number. In some embodiments, the product information may include a document type, a GTIN code, a manufacturing date, and an expiration date. The product information may also include a key criteria. In some embodiments, the one or more certificates include as least one of a certificate of analysis, a nutritional statement, and kosher certification.

The repository may then generate an electronic document based on the received document that includes the product information, and may also generate electronic copies of the one or more certificates received. The electronic copies of the one or more certificates and the electronic document may be stored the repository. In one embodiment, the repository further generates a QR Code associated with the food product. In this embodiment, the electronic document includes the QR Code associated with the food product.

The repository may receive a query related to the food product which may be data generated by document recognition or by QR Code scanning. In one embodiment, scanning a QR Code included in the electronic document provides the query to the repository. In some embodiments, the electronic document including the QR Code is sent to the suppliers and manufacturers from the repository for their use. In one embodiment, the repository may then provide access to the electronic document and electronic copies of the one or more certificates associated with the query related to the food product. In some embodiments, the repository further generates a URL to retrieve the electronic document and the electronic copies of the one or more certificates.

In one embodiment, the document related to the food product and the one or more certificates related to the food product are being received by the repository from suppliers and manufacturers of the food product and the query related to the food product is being received by the repository from any of the suppliers, manufacturers, distributors, wholesalers and customers.

In another embodiment, an apparatus, comprising an electronic document generator, a database, and a query module, is used to store, track and disseminate documents related to a food product. The apparatus is a repository which may be a server or a cloud computing system. In one embodiment, the electronic document generator receives a document related to a food product and one or more certificates related to the food product. The document comprises product information including a supplier identification and a lot or batch number. The electronic document generator may generate an electronic document based on the document including the product information and may also generate electronic copies of the one or more certificates. In one embodiment, the database is coupled to the electronic document generator and stores the electronic copies of the electronic document and the one or more certificates. In this embodiment, the query module is coupled to the database and receives a query related to the food product. The query may be data generated by document recognition or by QR Code scanning. In one embodiment, the query module provides access to the electronic document and electronic copies of the one or more certificates associated with the query related to the food product.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 shows a block diagram illustrating one embodiment of a system to store, track and disseminate documents related to food products.

FIG. 2 shows a block diagram illustrating one embodiment of an apparatus to store, track and disseminate documents related to food products.

FIG. 3 shows a flow diagram of one embodiment of a method of storing, tracking and disseminating documents related to food products.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

In the following description, certain terminology is used to describe features of the invention. For example, in certain situations, the terms “component,” “unit” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a micro-controller, etc.). Of course, the hardware may be alternatively implemented as a finite state machine or even combinatorial logic.

The following description is the divided into two parts. Part I gives an overview of the systems and apparatuses in which an embodiment of the invention may be implemented. Part II describes methods of storing, tracking and disseminating documents related to food products.

### Part I. Overview of Systems and Apparatuses

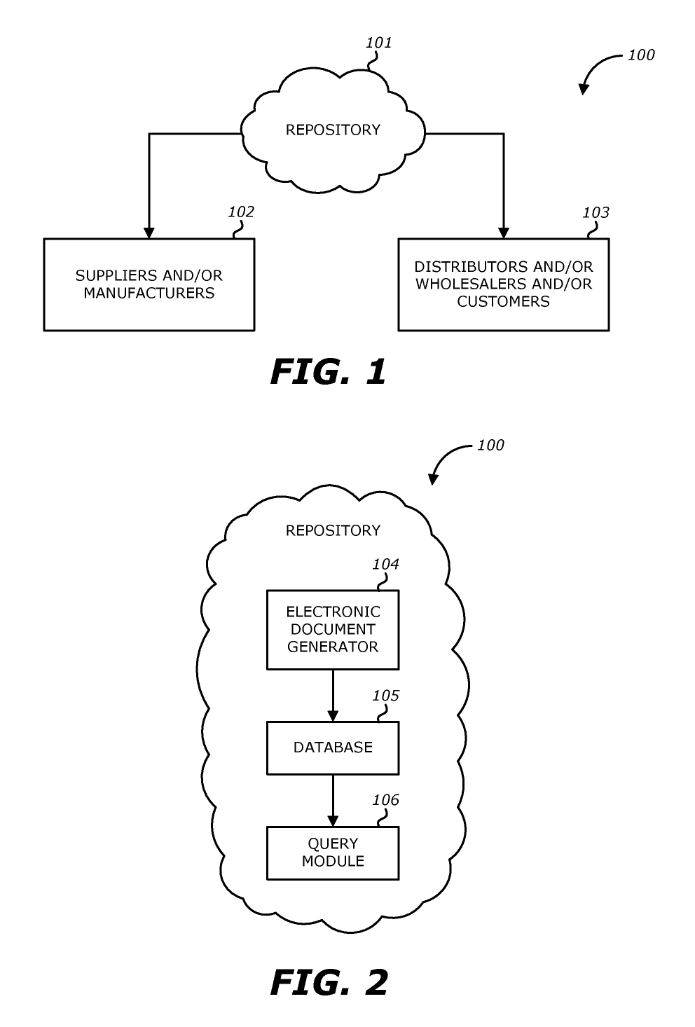

FIG. 1 shows a block diagram illustrating one embodiment of a system to store, track and disseminate documents related to food products. The system 100 comprises a repository 101, suppliers and/or manufacturers 102, and distributors, wholesalers and/or customers 103. As illustrated in FIG. 1, the repository 101 which may be a server or a cloud computing system is communicatively coupled to suppliers and/or manufacturers 102 as well as distributors, wholesalers and/or customers 103. Accordingly, the suppliers and/or manufacturers 102 and distributors, wholesalers and/or customers 103 may communicate with the repository 101 via the Internet using transmission mediums. The transmission mediums may include, but is not limited, to electrical wires, optical fiber, cable, a wireless link established by wireless signaling circuitry, or the like. Therefore, the repository 101 acts as a central system that may store documents received from the suppliers and/or manufacturers 102, track the documents and further disseminate documents on demand to the suppliers and/or manufacturers 102 as well as the distributors, wholesalers and/or customers 103.

FIG. 2 shows a block diagram illustrating one embodiment of a repository to store, track and disseminate documents related to food products. The repository 101 comprises an electronic document generator 104, a database 105 and a query module 106.

In one embodiment, the electronic document generator 104 receives a document related to a food product and one or more certificates related to the food product from the suppliers and/or manufacturers 102. The document that is provided from to the electronic document generator 104 may comprise product information which includes supplier identification and a lot or batch number. The supplier information may be a Universal Product Code (UPC), Global Trade Item Number (GTIN) or a Data Universal Number System (DUNS). The product information may include data such as a document type, a GTIN code, a manufacturing date, an expiration date, and a key criteria. In some embodiments, the key criteria may identify the one or more certificates that are required to be provided. With regards to the certificates related to food product, the suppliers and/or manufacturers 102 may provide, for instance, certificates such as a certificate of analysis (C.O.A.) which may contain lot codes, date of manufacture, country of origin or (C.O.O.), pack size or product weight, a nutritional statement, allergen information, product item information and a Kosher or other certifications including Halal. In one embodiment, the electronic document generator 104 generates an electronic document based on the document including the product information which it received from suppliers and/or manufacturers 102. The electronic document generator 104 may also generate electronic copies of the certificates that were received.

In some embodiments, the electronic document generator may generate a QR code associated with the food product and include the generated QR code in the electronic document associated with the food product. In other embodiments, the electronic document generator 104 generates a URL that provides access to and retrieval of the electronic document as well as the electronic copies of the certificates.

As illustrated in FIG. 2, the database 105 is coupled to the electronic document generator 104. Once the an electronic documents and the electronic copies of the certificates are generated by the electronic document generator 104, the electronic documents and the electronic copies of the certificates are sent to the database 105 and stored therein.

In some embodiments, the query module 106 is coupled to the database 105. The query module may receive a query related to the food product. The query may be sent by the suppliers, manufacturers 102, distributors, wholesalers or customers 103.

The suppliers, manufacturers 102, distributors, wholesalers or customers 103 may provide a document to a document recognition system which generates data. In this embodiment, the query may include data generated by document recognition. For example, a distributor 103 may upload a certificate of analysis. A document recognition system may recognize the certificate, extract the supplier identification such as a GTIN and include the GTIN into a query being sent to the repository 101.

In another embodiment, the query may include data obtained from scanning the QR code that is included in the electronic document. In this embodiment, the electronic document including the QR code related to the food product is provided to the suppliers and/or manufacturers 102 for their personal use. Upon demand, the suppliers and/or manufacturers 102 may provide this electronic document including the QR code to the distributors, wholesalers and/or customers 103. Scanning the QR code directs the query pertaining to the corresponding food product to the repository 101.

Upon receiving the query, the query module 106 may provide access to the electronic document and electronic copies of the certificates associated with the query related to the food product. For example, a manufacturer 102 may provide the customer 103 the electronic document including a QR code associated with a food product. Upon scanning the QR code, the query module 106 may receive a query including the GTIN and lot or batch number associated with the food product. The query module 106 may locate the electronic documents and electronic copies of the certificates related that query in the database 105 and further, provide access to the electronic documents and electronic copies of the certificates to the customer 103. In some embodiments, the customer 103 may interact with the repository 101 via a Graphic User Interface (GUI). For example, with respect to the given food product identified in the query, the GUI may include (i) a homepage that displays the various product information and (ii) links, tabs or icons that provide access to the electronic documents and copies of electronic certificates. Accordingly, the customer 103 that needs a copy of the kosher certificate may click on the corresponding link, tab or icon in the GUI and the query module 106 may provide the electronic copy of the kosher certificate which may be printed out by the customer 103.

Having the repository 101 act as a centralized system allows the suppliers and/or manufacturers 102 and the distributors, wholesalers and/or customers 103 to have access to the required documents and certificates in an organized database. In embodiments where a GUI is used to facilitate interaction with the repository 101, the GUI presents the various different documents and certificates that are stored in the database 105 in an organized manner to the user. The repository 101 also minimizes the amount of manual entering of data that is currently required at each stage of the supply chain. In other words, instead of requiring suppliers, manufacturers 102, distributors, wholesalers and customers 103 to maintain their own local databases, the repository 101 acts as a central database. Additionally, the various documents and certificates are easily tracked since they are all maintained in a central location. Further, the repository 101 may disseminate required information in a template form. Specifically, the repository 101 creates electronic versions of the documents it receives and the electronic documents may be created in a template form.

### Part II. Methods of Storing, Tracking and Disseminating Documents Related to Food Products

The following embodiments of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, etc. The processes are performed by processing logic that comprises hardware (e.g., circuitry, dedicated logic, etc.), software (such as is run on a general-purpose computer system or dedicated machine), or a combination of both.

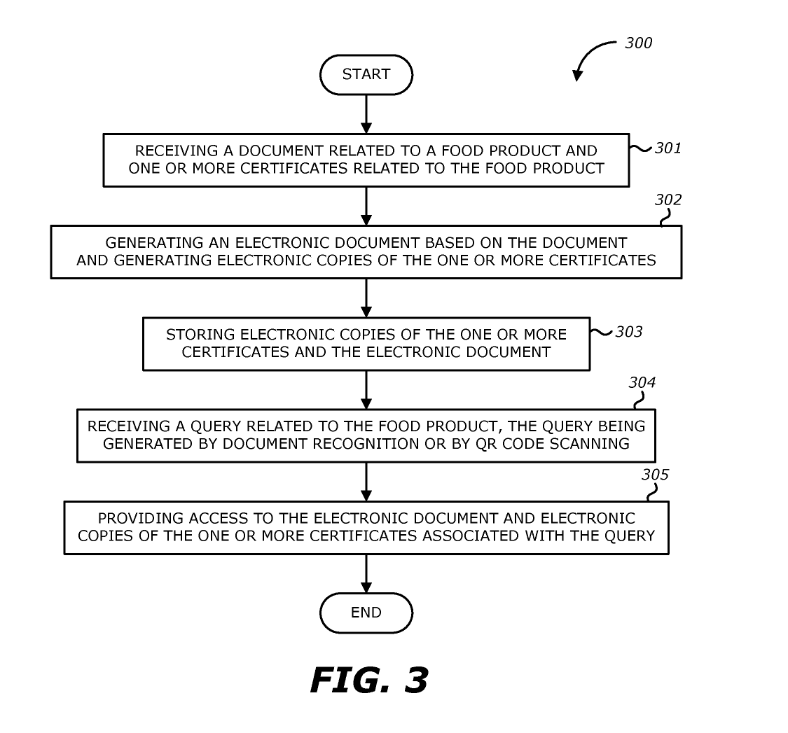

FIG. 3 shows a flow diagram of one embodiment of a method 300 of storing, tracking and disseminating documents related to food products. Method 300 may be performed by the repository 101 in FIGS. 1 and 2.

Method 300 begins with the repository receiving a document related to a food product and one or more certificates related to the food product at block 301. The document may comprise product information including a supplier identification and a lot or batch number. The supplier information may be at least one of: UPC, GTIN, and DUNS. The product information may include data such as a document type, a GTIN code, a manufacturing date, an expiration date, and a key criteria. The certificates may include a certificate of analysis, a nutritional statement, and kosher certification.

At Block 302, the repository generates an electronic document based on the document including the product information and generates electronic copies of the one or more certificates. In some embodiments, the repository generates a QR Code associated with the food product and the electronic document further includes the generated QR Code. In other embodiments, the repository generates a URL associated with the electronic document. The URL may subsequently be used to retrieve the electronic document and the electronic copies of the one or more certificates. At Block 303, the electronic copies of the one or more certificates and the electronic document are stored on the repository.

At Block 304, the repository receives a query related to the food product. The query may be data generated by document recognition or by QR Code scanning. For instance, if the electronic document includes a QR code, scanning the QR Code provides the query to the repository. At Block 305, the repository provides access to the electronic document and electronic copies of the one or more certificates associated with the query. In some embodiments, the users being provided access to the electronic documents and electronic copies of the certificates may interact with the repository via a GUI. Using the GUI, the users may, for example, view and print the electronic documents and the certificates stored in the database which are related to a given query.

An embodiment of the invention may be a machine-readable medium having stored thereon instructions which program a processor to perform some or all of the operations described above. A machine-readable medium may include any mechanism for storing or transmitting information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

What is claimed is:

1. A method of using a repository that stores, tracks and disseminates a plurality of documents and certificates respectively related to a plurality of food products, the plurality of documents being respectively associated with a supplier identification, the method comprising:
receiving, by the repository, a document related to a food product and one or more certificates related to the food product, the document comprises product information including a supplier identification and a lot or batch number, wherein the repository is a server or a cloud computing system;
generating, by the repository, an electronic document based on the document including the product information and generating, by the repository, electronic copies of the one or more certificates;
storing the electronic copies of the one or more certificates and the electronic document on the repository;
receiving, by the repository, a query related to the food product, the query being data generated by document recognition or by QR Code scanning; and
providing access to the electronic document and electronic copies of the one or more certificates associated with the query related to the food product.

2. The method of claim 1, wherein the supplier information is one of a Global Trade Item Number (GTIN) and a Data Universal Number System (DUNS).

3. The method of claim 1, wherein the product information further includes (i) a document type, (ii) a GTIN code, (iii) a manufacturing date, and (iv) an expiration date.

4. The method of claim 1, wherein the product information includes a key criteria, wherein the key criteria identifies certificates included in the one or more certificates that are required.

5. The method of claim 1, the one or more certificates includes at least one of a certificate of analysis, a nutritional statement, and kosher certification.

6. The method of claim 1, wherein the repository further generates a QR Code associated with the food product and the electronic document includes the QR Code associated with the food product, and wherein scanning the QR Code provides the query to the repository.

7. The method of claim 6, wherein the repository further generates a URL to retrieve the electronic document and the electronic copies of the one or more certificates.

8. The method of claim 1, wherein the document related to the food product and the one or more certificates related to the food product are being received by the repository from suppliers and manufacturers of the food product.

9. The method of claim 1, wherein the query related to the food product is being received by the repository from distributors, wholesalers and customers.

10. The method of claim 6, further comprising sending the electronic document including the QR Code to the suppliers and manufacturers.

11. An apparatus comprising:
an electronic document generator
to receive a document related to a food product and one or more certificates related to the food product, the document comprises product information including a supplier identification and a lot or batch number, and
to generate an electronic document based on the document including the product information and to generate electronic copies of the one or more certificates; a database coupled to the electronic document generator, the database
to store the electronic copies of the electronic document and the one or more certificates; and
a query module coupled to the database, the query module
to receive a query related to the food product, the query being data generated by document recognition or by QR Code scanning, and
to provide access to the electronic document and electronic copies of the one or more certificates associated with the query related to the food product.

12. The apparatus of claim 11, wherein the apparatus is a repository, the repository being a server or a cloud computing system.

13. The apparatus of claim 11, wherein the supplier information is one of a Global Trade Item Number (GTIN) and a Data Universal Number System (DUNS).

14. The apparatus of claim 11, wherein the product information further includes (i) a document type, (ii) a GTIN code, (iii) a manufacturing date, and (iv) an expiration date.

15. The apparatus of claim 11, the one or more certificates includes at least one of a certificate of analysis, a nutritional statement, and kosher certification.

16. The apparatus of claim 11, wherein the electronic document generator further generates a QR Code associated with the food product and the electronic document includes the QR Code associated with the food product, and wherein a scan of the QR Code provides the query to the query module.

17. The apparatus of claim 16, wherein the electronic document generator further generates a URL to retrieve the electronic document and the electronic copies of the one or more certificates.

18. The apparatus of claim 11, wherein the document related to the food product and the one or more certificates related to the food product are being received from suppliers and manufacturers of the food product.

19. The apparatus of claim 11, wherein the query related to the food product is being received from distributors, wholesalers and customers.

20. The apparatus of claim 16, further comprising sending the electronic document including the QR Code to the suppliers and manufacturers.
